(19) United States
(12) Patent Application Publication
(10) Pub. No.: US 2024/0116273 A1
(43) Pub. Date: Apr. 11, 2024

(54) MULTILAYER PACKAGING MATERIAL AND METHOD FOR MAKING SAME

(71) Applicants: Tizazu MEKONNEN, Waterloo (CA); Hormoz Eslami, Ancaster (CA)

(72) Inventors: Tizazu MEKONNEN, Waterloo (CA); Hormoz Eslami, Ancaster (CA)

(21) Appl. No.: 18/235,574

(22) Filed: Aug. 18, 2023

Related U.S. Application Data
(60) Provisional application No. 63/475,008, filed on Oct. 6, 2022.

(51) Int. Cl. B32B 9/06; B32B 9/02; B32B 37/12; B32B 37/24; B65D 85/804

(52) U.S. Cl. CPC B32B 9/06; B32B 9/02; B32B 37/12; B32B 37/24; B65D 85/8043; B32B 2037/243; B32B 2255/12; B32B 2255/26; B32B 2307/7376; B32B 2439/70; B32B 2553/00

(57) ABSTRACT

A multilayer packaging material including a substrate layer; a polar layer positioned atop the substrate layer; and a non-polar layer positioned atop the polar layer, opposite the substrate layer. The multilayer packaging material includes barrier properties and mechanical strength, while being compostable.

### CROSS-REFERENCE TO OTHER APPLICATIONS

The disclosure claims priority from U.S. Provisional Application No. 63/475,008 filed Oct. 6, 2022, which is hereby incorporated by reference.

### FIELD

The disclosure generally relates to packaging, and more particularly to a multilayer packaging material and method for making same.

### BACKGROUND

Packaging plays a vital role in the safety and quality of products, such as food and pharmaceutical products, by protecting them from chemical, physical, and environmental factors. The transportation and distribution of such products to broad and remote destinations at low cost with ease necessitates lightweight flexible packaging (FP), which is mainly derived from plastics. Plastic derived packaging material is versatile, convenient, and has important environmental benefits as it reduces product waste by providing improved shelf-life, and reducing transportation energy and cost as opposed to metal and glass-based packaging alternatives. However, packaging-related plastic waste is also responsible for the generation of at least 36% of the total solid polymer waste, accounting for over 400 million tons of global waste.

Despite widespread interest, the production of biodegradable FP is not straightforward. Moreover, the food industry is the primary user of FPs, with up to 60% by volume of all FPs facing specific performance-related challenges. Firstly, food products have the most geographically widespread applications globally, resulting in a significant demand for lightweight FP for their inexpensive and easy transport to remote destinations. Secondly, more often than not, the FP produced to the highest standards of the food industry is designed to keep food for as long as possible. Consequently the FPs themselves are required to have longer life making them even more persistent in the environment, despite the growing need for the development of biodegradable and compostable packaging materials. Thirdly, plastic recyclers refuse to accept FPs that have direct contact with food because they often contain organic matter that requires additional cleaning before reprocessing or repurposing. According to many municipal regulations, these wastes must be disposed of with regular garbage, increasing the costly landfill volume.

The main challenges for the commercialization of these polymers are usually their high price, less favorable mechanical properties, poor barrier properties, and low biodegradation rates. The limited choices for biodegradable polymers and their individual shortcomings have resulted in more multilayer FP (MLFP) tendency. An MLFP usually includes different layers that each provide a different set of functions to the ensemble like structural strength, barrier properties, or tie/adhesion/sealing capabilities.

Therefore, there is provided a novel multilayer packaging material and method for fabricating same.

### SUMMARY

It should be appreciated that this summary is provided to introduce a selection of concepts in a simplified form that are further described below in the detailed description of embodiments. This summary is not intended to be used to limit the scope of the claimed subject matter.

In one aspect of the disclosure, there is provided a multilayer packaging material including a substrate layer; a polar layer positioned on one side of the substrate layer; and a non-polar layer positioned on the polar layer, opposite the substrate layer.

In another aspect, the polar layer is a polar starch layer. In yet another aspect, the polar layer includes at least one of a starch, thermoplastic starch (TPS), cellulose acetate, cellophane, or polyvinyl alcohol. In a further aspect, the substrate layer includes at least one of paper, cellulose acetate, cellophane, polyvinyl alcohol. In yet a further aspect, the substrate layer comprises paper and the intermediate layer comprises thermoplastic starch (TPS). In another aspect, the non-polar layer includes at least one of polylactic acid (PLA), poly(butylene adipate-co-terephthalate) (PBAT), poly(3-hydroxybutyrate-co-3-hydroxyvalerate) (PHBV), or polyvinyl alcohol (PVOH).

In another aspect, a thickness of the polar layer is in the range of 0.1 μm to 1 mm. In another aspect, a thickness of the non-polar layer is in the range of 0.1 μm to 1 mm. In yet a further aspect, the polar layer and the non-polar layer have different polarities.

In another aspect of the disclosure, there is provided a packaged product including a product for a consumer; and a packaging surrounding the product, the packaging comprising the multilayer packaging material as defined in Claim 1.

In another aspect, the product is a single use beverage pod. In yet another aspect, the packaging includes multiple pieces of the multilayer packaging material. In a further aspect, the multiple pieces of the multilayer packaging material are connected to each other via their non-polar layers. In a further aspect, the multiple pieces of multilayer packaging material are heated to bond a portion of their non-polar layers together.

In yet another aspect of the disclosure, there is provided a method of manufacturing a multilayer packaging material including providing a substrate layer; positioning a polar layer atop the substrate layer; and positioning a non-polar layer atop the polar layer, opposite the substrate layer.

In another aspect, positioning the polar layer atop the substrate layer includes applying a polar layer solution to the substrate layer. In a further aspect, positioning the polar layer atop the substrate layer further includes drying the polar layer solution. In yet another aspect, positioning the polar layer atop the substrate layer includes adhering a prefabricated polar layer to the substrate layer. In an aspect, positioning the non-polar layer atop the polar layer includes applying a non-polar layer solution to the polar layer; and drying the non-polar layer solution. In a further aspect, positioning the non-polar layer atop the polar layer includes adhering a pre-fabricated non-polar layer to the polar layer.

### BRIEF DESCRIPTION OF THE DRAWINGS

Embodiments will now be described more fully with reference to the accompanying drawings, in which:

FIG. 1 is an axonometric view of a multilayer packaging material;

FIG. 2 is a side view of a packaged product with the packaging shown in cross-section;

FIG. 3a is a flowchart outlining a method of manufacturing multilayer packaging material;

FIG. 3b is a flowchart of another method of manufacturing multiple packaging material;

FIGS. 4a to 4c shows the structures of different polymers for use in the non-polar or facing layer;

FIGS. 5a to 5y are images of different multilayer packaging materials using a scanning electron microscope;

FIG. 6a shows mechanical test results for dry sample tensile strength (MPa);

FIG. 6b shows mechanical test results for dry sample Young's modulus (MPa);

FIG. 6c shows mechanical test results for dry sample Elongation at break (%);

FIG. 6d shows mechanical test results for wet sample tensile strength (MPa);

FIG. 6e shows mechanical test results for wet sample Young's modulus (MPa);

FIG. 7a shows test results for tear strength (N/mm);

FIG. 7b shows a relationship between the tear strengths and the tensile moduli of the samples;

FIG. 8a shows seal peel strength results;

FIG. 8b is a schematic diagram of peeling action on a sealed sample;

FIG. 9a show test results with respect to oxygen permeance;

FIG. 9b shows test results with respect to water weight loss during water vapor transmission test;

FIG. 9c shows test results with respect to water vapor transmission rates where (I) and (S) denote the initial and steady rates respectively;

FIG. 10a shows Cobb test results after 60 seconds contact with water (WCobb60);

FIG. 10b shows Cobb test results after 180 seconds contact with water (WCobb180);

FIG. 10c shows Cobb test results after 60 seconds contact with corn oil (OCobb60);

FIG. 10d shows Cobb test results after 180 seconds contact with corn oil (OCobb180);

FIG. 11a shows the rheological behavior of polymer solutions PHBV, PBAT and PLA in chloroform and PVOH in water at ambient temperature;

FIG. 11b shows a thixotropic loop for TPS at 70° C.; and

FIG. 11c shows shear stress relating to shear rate curves for TPS solutions at 30, 50, and 70° C.

### DETAILED DESCRIPTION

The foregoing summary, as well as the following detailed description will be better understood when interpreted in conjunction with the accompanying drawings.

As used herein, an element described in the singular and preceded by the word “a” or “an” should be understood as not necessarily excluding a plural of the elements. Further, references to “one example”, “an example”, “one embodiment”, or “an embodiment” with a described element are not intended to be interpreted as excluding the existence of additional examples or embodiments with the described element. Moreover, unless explicitly stated to the contrary, examples or embodiments “comprising”, “having”, “with”, or “including” an element having a particular property may further include additional elements not having that particular property. Additionally, references to an example or an embodiment throughout the disclosure may, but do not necessarily, refer to the same example or embodiment.

As used herein, it will be understood that the terms “comprises”, “has”, “with”, and “includes” all mean “including but not limited to” and the terms “comprising”, “having”, and “including” have equivalent meaning. As used herein, the term “and/or” can include any and all combinations of one or more of the associated listed elements or features.

When an element is referred to as being “on”, “attached”, “connected”, “coupled”, “contacting”, “bonded”, or similarly engaged to another element, that element may be directly or indirectly on, attached, connected, coupled, contacting, or bonded to the other element. However, when an element is referred to as being “directly on”, “directly attached”, “directly connected”, “directly coupled”, “directly contacting”, “directly bonded”, or similarly directly engaged to another element, there are no intervening elements present. Also, integrally formed elements can be referred to as being on, attached, connected, coupled, contacting, bonded, or similarly engaged to each other, and can further be referred to as being directly on, directly attached, directly connected, directly coupled, directly contacting, or similarly directly engaged to each other when no other elements are integrally formed therebetween.

Spatially relative terms, such as “under”, “below”, “lower”, “over”, “above”, “upper”, “front”, “back”, and the like, may be used herein for ease of describing the relationship of one element to another, such as the relationship shown in the accompanying figures. However, elements described with spatially relative terms may encompass different orientations in use or operation without departing from the disclosure.

Unless otherwise indicated, the terms “first”, “second”, etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, references to an element being “configured” to perform a function denotes a state of configuration that fundamentally ties that element to the function and does not include elements that are unintuitively capable of performing the function.

As used herein, the terms “approximately” and “about” represent an amount close to the stated amount that still performs the desired function or achieves the desired result. For example, the terms “approximately” and “about” can refer to an amount that is within engineering tolerances that would be readily appreciated by a person skilled in the art.

The disclosure is directed at a multilayer packaging material and methods for fabricating the multilayer packaging material. The disclosure is also directed at packaging that can be made from the multilayer packaging material.

In one embodiment, the multilayer packaging material includes a substrate layer, a non-polar layer and a polar layer. In some embodiments, the multilayer packaging material may include a substrate layer, multiple non-polar layers and multiple polar layers. In some embodiments, the multilayer packaging material may include only one substrate layer, one polar or intermediate layer and one non-polar or facing layer.

In some embodiments, the polar layer is a polar starch layer.

A polar layer may be defined as a layer made of macromolecules or its chemical groups having an electric dipole moment, with a positive charged end and a negative charged end, while a non-polar layer may be defined a layer that does not have electric charge or partial charge. In most embodiments, the polar layer is sandwiched between the substrate layer and the non-polar layer.

In one embodiment, the non-polar layer may be seen as a facing layer. In some embodiments, the facing layer improves oil and water resistance and may provide water vapor transmission barrier properties. When packaging is built using the multilayer packaging material, the facing layers of two different sections of packaging material are mated or connected to form the packaging structure such that each of the facing layers form the inside walls of the packaging, however, the facing layers may also form external walls in some embodiments.

The polar layer may be seen as an intermediate layer as it is located between the substrate layer and the facing layer. The intermediate layer reduces oxygen and air permeabilities and may promote adhesion between the intermediate layer and the facing layer and the intermediate layer and the substrate layer.

In one embodiment, the packaging material includes a substrate layer (which in some embodiments may be a layer of paper), a polar layer (which in some embodiments may be a thermoplastic starch (TPS) layer), and a non-polar layer (which in some embodiments may be a polymer layer).

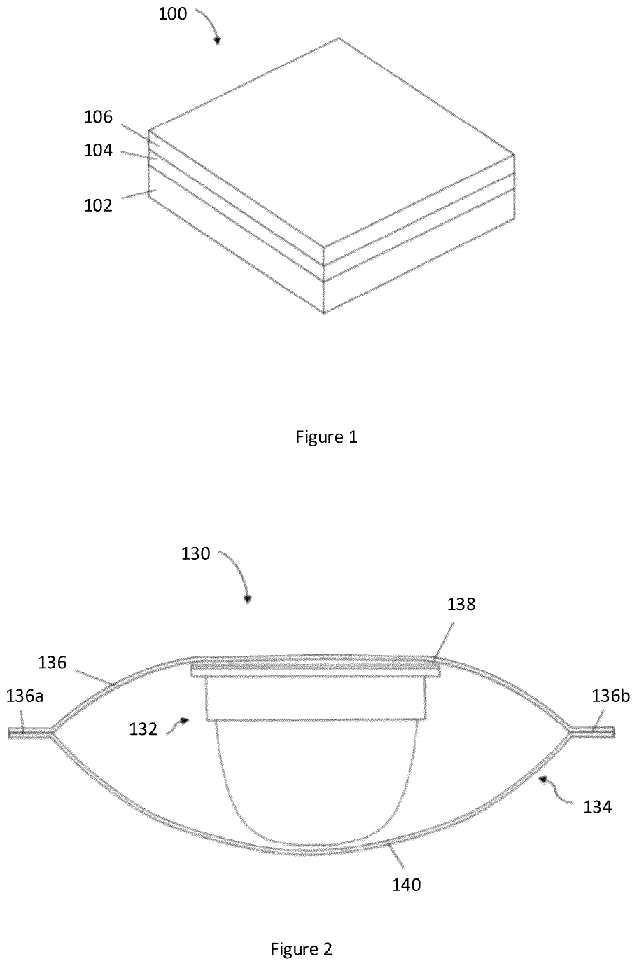

Turning to FIG. 1, multilayer packaging material or a multilayer packaging assembly is shown and generally identified by reference character 100. As will be appreciated, the multilayer packaging material 100 shown in FIG. 1 is not to scale and proportions have been adjusted to facilitate understanding of the disclosure.

The multilayer packaging material 100 includes a substrate layer 102, an intermediate, or polar, layer 104, and a facing, or non-polar, layer 106. In one embodiment, the intermediate layer 104 is positioned atop, bonded, or applied, to the substrate layer 102 and the facing layer 106 is then positioned atop, bonded, or applied to the intermediate layer 104, on a side of the intermediate layer opposite the substrate layer 102 whereby the intermediate layer 104 is interposed between the substrate layer 102 and the facing layer 106. Different methods of positioning, bonding or applying the layers is described in more detail below. In some embodiments, such as the one shown in FIG. 1, the intermediate layer 104 is directly bonded to the substrate layer 102, and the facing layer 106 is directly bonded to the intermediate layer 104. The substrate layer 102, the intermediate layer 104, and the facing layer 106 cooperate to provide a barrier or barrier properties and mechanical strength to the multilayer packaging material 100.

The barrier properties and the mechanical strength of the packaging material 100 may be controlled via the characteristics of the multiple layers. These characteristics may include, but are not limited to, a thickness of each layer, the material selected for each layer or the adhesion between the different layers. The barrier properties are directed at providing a packaging material 100 that will inhibit or reduce permeation of molecules (either entering or exiting) through the multilayer packaging material 100 when it is fabricated into packaging for transport of an object or item, such as a single use beverage pod or other product for a consumer. The object may also be a non-food item. As will be appreciated, the barrier properties and the mechanical strength of the multilayer packaging material 100 may be selected based on an intended application for the multilayer packaging material 100 or the type of packaging that the material 100 is to be used for.

The substrate layer 102 is configured to provide mechanical strength to the multilayer packaging material 100 and may also help to provide the barrier properties for the multilayer packaging material 100. In some embodiments, when packaging is formed with the multilayer packaging material 100, the substrate layer 102 is the layer that is on the outside of the packaging, however, in other embodiments, the substrate layer 102 may be on the inside of the packaging.

In one embodiment, the substrate layer 102 is made of paper, however, other materials such as, but not limited to, cellulose acetate, cellophane, polyvinyl alcohol or a combination of paper, cellulose acetate, cellophane and/or polyvinyl alcohol may be selected. In some embodiments, the substrate layer 102 may have a polarity but it does not necessarily have to be polar. In one specific embodiment, the substrate layer 102 is multi-purpose white paper with 72 g/m² grammage, 92 bright (PEN+Gear™) and a nominal thickness of 92 μm.

The intermediate, or polar, layer 104 is configured to promote adhesion between the different layers of the multilayer packaging material 100 to improve overall bonding of the multilayer packaging material 100. In one embodiment, the intermediate layer 104 is made of TPS, however, other materials such as, but not limited to, cellulose acetate, cellophane, polyvinyl alcohol or a combination of TPS, cellulose acetate, cellophane and/or polyvinyl alcohol may be selected. In one specific embodiment, when the intermediate layer 104 is made from TPS, the intermediate layer 104 may have a thickness in the range of approximately 0.1 μm to 1 mm. More specifically, the thickness may be in the range of 1 to 50 μm. The intermediate layer 104 enhances the mechanical strength of the multilayer packaging material 100.

The intermediate layer 104 may also be configured to reduce or inhibit permeation of molecules through the multilayer packaging material 100 to help provide a barrier for the multilayer packaging material 100. The intermediate layer 104 can be seen as providing a supplementary barrier. The supplementary barrier is at least one of an oxygen barrier or an air barrier. The barrier properties of a layer depend on how readily or poorly a molecule can permeate the layer. Permeation of molecules through a layer is correlated to ease of diffusion of the molecules through the layer, which is influenced by the polarity of the layer. Accordingly, to hinder the diffusion path for different molecules, it is generally desirable to provide at least one polar in the multilayer packaging material 100. The intermediate layer 104 is generally polar and in contrast, the facing layer 106 is generally non-polar.

The facing, or non-polar, layer 106 is configured to reduce or inhibit permeation of molecules through the multilayer packaging material 100. As will be appreciated, the intermediate layer 104 and the facing layer 106 can inhibit the same or different molecules.

In some embodiments, the facing layer 106 provides a barrier to external contamination wherever it is located within the multilayer packaging material. The primary barrier provided by the facing layer 106 cooperates with the supplementary barrier provided by intermediate layer 104 to help provide the barrier properties for the multilayer packaging material 100. As discussed above, the facing, or non-polar, layer 106 and the intermediate, or polar, layer 104 have different polarities which work together to reduce or inhibit diffusion of molecules through the multilayer packaging material 100 either from outside of the packaging to inside or vice-versa. The primary barrier is at least one of a moisture barrier and/or an oil barrier.

The facing layer 106 also enhances the mechanical strength of the multilayer packaging material 100. In some embodiments, the facing layer 106 may be selected from PLA, PBAT, PHBV, PHOV or a combination thereof. In one specific embodiment, the facing layer 106 may have a thickness in the range of approximately 0.1 μm to 1 mm. More specifically, the thickness may be in the range of 1 to 50 μm.

In some embodiments, PLA can be formed from a PLA resin such as, but not limited to, Ingeo™ biopolymer 4043D general grade. In some embodiments, PBAT can be formed from pellets, such as, but not limited to, PBAT Galaxy Chemical pellets. In some embodiments, PHBV can be formed from PHBV resins with a nominal 3HV percent of 1%. In some embodiments, if PVOH is used, the PVOH can have a hydrolysis of ˜88 to 90%.

The facing layer 106 is configured to enable self-sealing or sealing of the multilayer packaging material 100. Accordingly, different pieces of multilayer packaging material 100 can be sealed together by placing a section or portion of the different facing layers in face-to-face, or direct, contact with each other and temporarily heating the sections above the melting temperature of the facing layer 106. The melting temperature of the facing layer 106 is based on the material selected for the facing layer 106. For example, if PBAT is used, the facing layer 106 may have a melting temperature at around 185° C. In some embodiments, packaging made from the multilayer packaging material 100 can be sealed by other methodologies, such as via adhesives. In some embodiments, the facing layer 106 is the innermost layer of the packaging made from the multilayer packaging material 100, such as in embodiments where the facing layer 106 is used to self-seal the packaging.

The multilayer packaging material 100 is also compostable, or biodegradable, as the substrate layer 102, the intermediate layer 104, and the facing layer 106 are all formed from materials that are compostable. By providing packaging that provides barrier properties and/or mechanical strength, while also being fully compostable, use of the multilayer packaging material 100 in fabricating transportation packaging can help to reduce pollution.

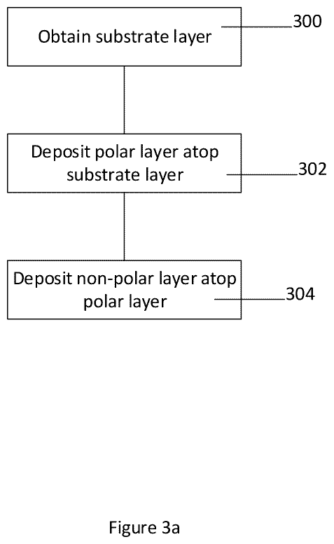

Turning now to FIG. 2, a packaged product is shown and generally identified by reference character 130. The packaged product 130 includes a product 132 and packaging 134 (made from the multilayer packaging material 100) that surrounds the product 132.

The packaging 134 further includes a flexible membrane 136, which surrounds the product 132. The flexible membrane 136 includes an overlying, or first, portion 138 and an underlying, or second, portion 140. In the current embodiment, the overlying portion 138 and the underlying portion 140 are both formed entirely of the multilayer packaging material 100. In use, the packaging 134 may be sealed by pressing together the overlying portion 138 and the underlying portion 140 at the ends 136a, 136b of the flexible membrane 136 and heating the ends 136a, 136b above the melting temperature of the facing layers 106, until the ends 136a, 136b are sealed together. In other embodiments, the ends 136a and 136b of the packaging 134 can be sealed together using adhesives or other suitable mechanisms.

In the current embodiment, the product is a single use beverage pod. The product may also be granule coffee seed or another food product. In other embodiments, the packaged product can be a biomedical product, another consumer product or a non-food item.

When exposed to an external environment, undesirable molecules in the external environment may cause the product 132 to diminish in quality. Accordingly, to increase shelf-life and preserve the quality of the product 132, it is generally desirable to protect the product 132 from these molecules.

As discussed above, the material 100 used in the packaging 134 is configured to provide barrier properties to protect the product 132 from undesirable molecules. The packaging 134 can also be configured to provide mechanical strength in order to avoid or reduce unintentional tearing or opening of the packaging 134. When the packaging 134 is made entirely from the multilayer packaging material of FIG. 1, the packaging 134 is also fully compostable.

In other embodiments, the packaging 134 may include other materials along with the multilayer packaging material 100. For example, in some embodiments, the packaging 134 can include a lid formed of the multilayer packaging material 100 and a rigid or semi-rigid body formed of another packaging material, such as, but not limited to, cardboard. The lid can be sealed to the body by thermal fusing, adhesives, or other suitable sealing mechanisms. It is understood that the lid still provides barrier properties and mechanical strength.

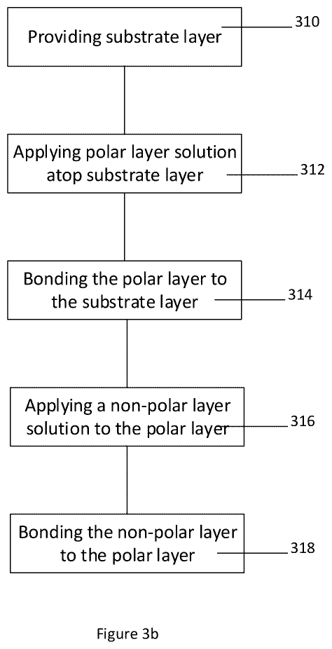

Turning now to FIG. 3a, a flowchart showing a first method of manufacturing or fabricating multilayer packaging material is generally shown. In one embodiment, the method is used to manufacture the multilayer packaging material 100 of FIG. 1. Initially, a substrate layer is obtained (300). In one embodiment, the substrate layer is paper although other materials, such as, but not limited to, cellulose acetate, cellophane, polyvinyl alcohol may be selected or a combination of these materials.

An intermediate layer, such as a polar layer, is then deposited, or positioned, atop the substrate layer (302). In some embodiments, the intermediate or polar layer is deposited (such as in liquid form and then dried) and, in other embodiments, a previously formed or pre-fabricated intermediate layer may be bonded or applied to the substrate layer. In yet further embodiments, the intermediate layer may be applied to the substrate layer by applying an intermediate layer or polar layer solution made from a starch material to the substrate layer. In one embodiment, the starch material is TPS although other starches such as, but not limited to, modified or functionalized starch or starch esters are contemplated. In other embodiments, the intermediate or polar layer may be made from at least one of a starch, cellulose acetate, cellophane, and polyvinyl alcohol (PVOH) or a combination thereof.

In another embodiment, applying the intermediate layer or polar layer solution to the substrate layer includes applying the intermediate layer solution using a doctor blade applicator, or other suitable applicator in order to position a polar layer atop the substrate layer. In one embodiment, the intermediate layer solution is applied in a first direction which may can be a longitudinal direction of the multilayer packaging material. In one specific embodiment, the intermediate layer solution may be an approximately 6 v/v % concentration solution of TPS. In other embodiments, the TPS may be formed from cornstarch (73% amylopectin and 27% amylose) and glycerol (99%).

In another specific embodiment of depositing the intermediate layer, an approximately 200 μm wet film thickness of the intermediate layer solution is applied to the substrate layer. As the intermediate layer solution dries, the intermediate layer is formed and bonds to the substrate layer. As the intermediate layer solution dries, the thickness of the intermediate layer may decrease.

In other embodiments, the intermediate layer may be formed separately, or pre-fabricated, and adhered to the substrate layer, such as via an adhesive or bonded via thermal fusing. This may be seen as positioning the polar layer atop the substrate layer. In thermal fusing, the pre-fabricated intermediate layer can be heated and pressed against the substrate layer to bond the intermediate layer to the substrate layer. In yet other embodiments, the substrate layer may also be heated to help bond the intermediate layer to the substrate layer.

A facing layer, such as a non-polar layer, is then positioned atop, deposited, bonded or adhered to the intermediate layer (304). In yet further embodiments, the facing layer may be applied to the intermediate layer by applying a facing layer or non-polar layer solution made from a non-polar material, such as a polymer. In other embodiments, the facing layer may be pre-fabricated and then positioned atop, adhered or bonded to the intermediate layer.

In some embodiments, applying a facing, or non-polar, layer solution to the intermediate layer includes applying the facing layer solution using a doctor blade applicator, or other suitable applicator. As will be understood, the facing layer solution is applied to the side of the intermediate layer opposite the substrate layer. In one embodiment, the facing layer solution is applied in a second direction with respect to the first direction that the intermediate layer solution was applied. In some embodiments, the second direction can be different from the first direction. For example, in some embodiments, the second direction is perpendicular to the first direction. Accordingly, in some embodiments, the second direction is in a lateral direction of the multilayer packaging material.

In some specific embodiments, the facing layer solution includes at least one of a solution of chloroform (HPLC grade) and PHBV, PLA or PBAT, or a solution of PVOH and water. Although the facing layer solution has been shown and described herein as comprising one of PLA, PBAT, PHBV and PVOH, it will be appreciated that in other embodiments the facing layer solution may include at least two of PLA, PBAT, PHBV, and PVOH.

When applying the facing layer solution to the intermediate layer, in one embodiment, the facing layer solution is applied to the intermediate layer 104 and allowed to dry. As the facing layer solution dries, the thickness may decrease and the facing layer 106 is formed.

In other embodiments, the facing layer 106 may be formed separately and adhered or bonded to the intermediate layer to position the facing layer atop the intermediate layer. Bonding of a prefabricated, or pre-formed, facing layer may be performed by thermal fusing. In other words, the facing layer can be heated and pressed against the intermediate layer to bond the facing layer to the intermediate layer. In some embodiments, the intermediate layer may also be heated to help bond the facing layer to the intermediate layer. Adhesives may also be used to bond or adhere the pre-formed facing layer to the intermediate layer.

Turning to FIG. 3b, a flowchart showing another method of fabricating a multilayer packaging material is shown. In FIG. 3b, the method includes providing a substrate layer (310), applying a polar or intermediate layer solution to the substrate layer to provide an intermediate layer (312), bonding the polar or intermediate layer to the substrate layer (314), applying a facing, or non-polar, layer solution to the intermediate layer to provide a facing layer (316), and bonding the facing layer to the intermediate layer (318).

Providing the substrate layer (310) includes providing the substrate layer 102 as described above. Applying the polar layer or intermediate layer solution to the substrate layer (312) may include applying the intermediate layer solution (made from a starch material) using a doctor blade applicator, or other suitable applicator. The intermediate layer solution may be applied as taught above.

In this embodiment, bonding the intermediate layer to the substrate layer (314) includes drying the intermediate layer solution. As the intermediate layer solution dries, the intermediate layer 104 is formed and bonds to the substrate layer.

In the current embodiment, applying the facing layer solution to the intermediate layer (316) includes applying the facing layer solution using a doctor blade applicator, or other suitable applicator. The facing layer solution may be applied in a manner as taught above.

Bonding the facing layer to the intermediate layer (318) includes drying the facing layer solution. As the facing layer solution dries, the facing layer 106 is formed and bonds to the intermediate layer.

In alternative embodiments, although the facing layer 106 has been shown and described as a single layer, the facing layer can include a plurality of constituent layers. For example, in some embodiments the facing layer may include multiple layers, such as, first and second constituent layers, that are bonded together. It is understood that more than two constituent layers are also contemplated. The first constituent layer can be one of PLA, PBAT, PHBV, PVOH, or blends thereof, and the second constituent layer can be a different one of PLA, PBAT, PHBV, PVOH, and different blends thereof.

Furthermore, with respect to the method of FIG. 3b, in some embodiments, applying an intermediate layer solution to provide an intermediate layer and applying a facing layer solution to provide a facing layer, may be omitted. For example, in some embodiments, one or both of the intermediate layer and the facing layer may be formed or fabricated separately and provided as part of the method of manufacturing the multilayer packaging material.

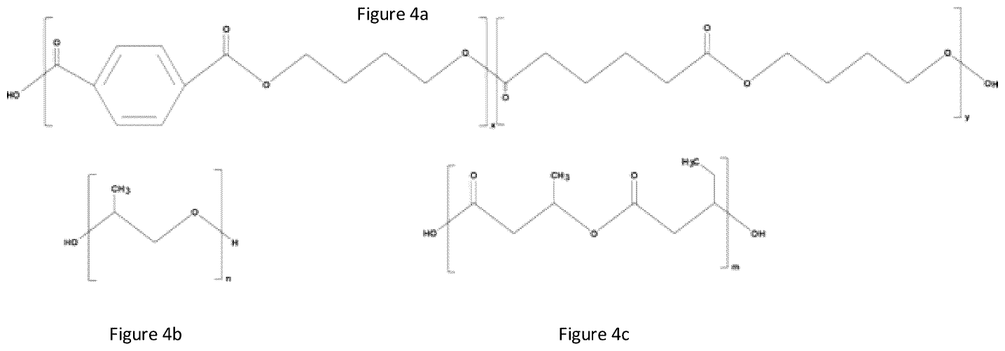

In one embodiment of use, although the nature of food aroma, in general, is still not well defined, in the case of products like coffee, it is believed to be broadly based on the volatile organic compounds (VOCs). In other embodiments, the multilayer packaging material may be used to hold non-food products. As the intermediate layer is designed to be polar (such as when TPS is used) with a high-volume density of hydroxyl groups and the non-polar facing layer (such as when PBAT, PLA or PHBV is used) has an organic polymer backbone, their polarities are different. FIG. 4a shows the chemical structure of PBAT; FIG. 4b shows the chemical structure of PLA and FIG. 4c shows the chemical structure of PHBV. Since polarity is an important contributor for a molecule to dissolve in any membrane and to diffuse (Fickean diffusion) across it, a combination of polar and non-polar layers reduces and/or hinders diffusion paths for any individual VOC species and keeps the overall aroma intact.

In experiments, different embodiments of multilayer packaging material were fabricated and tested. It is understood that the following description relates to specific embodiments but the measurements should not be seen as limiting or narrowing and are provided as one possible embodiment of multilayer layer packaging material. A multi-purpose white paper with 72 g/m² grammage, 92 bright, and nominal thickness of 92 μm was used as the substrate layer. The intermediate layer was fabricated using Corn Starch (73% amylopectin and 27% amylose) chloroform (HPLC grade) and glycerol (99%) and different facing layers made from PLA resin (Ingeo™ biopolymer 4043D general grade); PBAT pellets; PVOH with a hydrolysis of approximately 88-90% and PHBV resin (with a nominal 3HV percent of 1) were fabricated. Deionized water was used to prepare all aqueous solutions and preparative works.

In the experiments, different facing layers were formed by creating different facing layer solutions that were applied to individual intermediate layer and substrate layer combinations and then allowed to dry to form the facing layer.

One facing layer solution included a 5 wt. % solution of PHBV in chloroform that was prepared by pre-dispersing the PHBV in chloroform at room temperature under vigorous mixing on a stir plate (450 rpm for 5 min). The temperature was then raised to 50° C. under slow mixing (150 rpm for 4 h) to obtain complete dissolution. The PHBV facing layer solution was then cooled and kept in a capped container and was heated to 50° C. prior to application. Other facing layer solutions included 5 wt. % PLA and PBAT solutions that were both prepared at room temperature in chloroform by mixing at 250 rpm overnight. A 7.66 wt. % PVOH facing layer solution in water was prepared by vigorous mixing on a stir plate (550 rpm) for 1 hour followed by overnight mixing at a slower rate (250 rpm) overnight. The solution was filtered through a 40-mesh screen, and the filtrate was used for the paper coating experiments.

The polymer solution viscosities were studied using a rheometer with a parallel plate spindle of 35 mm diameter and a gap of 1000 μm and it was determined that all the polymer facing layer solutions were 6 v %. The samples were first checked for conformity to linear viscoelasticity using amplitude scanning rheometry at 1 Hz. The chloroform-based solutions and aqueous PVOH solution in water were studied at ambient temperature, and TPS solution was studied at 30, 50, and 70° C. under stepped-ramp controlled shear (CS) conditions.

A TPS coated paper was also fabricated which represented the substrate layer and the intermediate, or polar, layer. In fabricating the substrate layer and intermediate layer combination, a 5.8 wt. % of starch was pre-dispersed in water at room temperature and mixed vigorously on a stir plate (650 rpm for 5 min). 30 wt. % glycerol with respect to starch was then added to the mixture, and the temperature was raised and maintained at approximately 85° C. (150 rpm for 30 min) to complete gelatinization. The solution was filtered through a 40-mesh screen, and the filtrate was used to coat the paper substrate layer immediately. Based on preliminary tests, a TPS solution with a total solid content of 8.3% was used to coat the paper. An adjustable doctor blade was employed to make a final dry thickness coating of approximately 12 μm along the length direction of the paper sheet. The TPS coated paper sheets (210×297 mm) were allowed to dry for at least 24 hours before applying the next layer of paper coating (the facing layer), cutting, or further testing.

The facing layer was applied to the dried TPS-coated paper sheets (intermediate and substrate layers) by coating the sheets with a layer of the PLA, PBAT, PHBV, or PVOH using the corresponding polymer solutions described above along the paper width direction to obtain a dry thickness of approximately 12 μm for each polymer. The polymer-TPS-coated papers (or different multilayer packaging materials) were then left to dry for at least 24 hours after each step and cut to the required dimensions for subsequent tests. The sample names and descriptions are presented in Table 1.

TABLE 1
Samples names, compositions and description.

| | | Paper | TPS | Polymer/ |
|---|---|---|---|---|
| Sample | | Thickness | Thickness | Thickness |
| Name | Description | (μm) | (μm) | (μm) |
| Paper | Paper baseline | 92 | 0 | 0 |
| PT | Paper - TPS | 92 | 12 | 0 |
| PTPLA | Paper-TPS-PLA | 92 | 12 | PLA/12 |
| PTPBAT | Paper-TPS-PBAT | 92 | 12 | PBAT/12 |
| PTPHBV | Paper-TPS-PHBV | 92 | 12 | PHBV/12 |
| PTPVOH | Paper-TPS-PVOH | 92 | 12 | PVOH/12 |

Different tests including a tensile test, a seal peel test, a water vapour transmission test, a Cobb test, an oxygen permeation test and a kit test were then performed on the different multilayer packaging materials. In order to obtain the results, the different multilayer packaging materials were studied using a scanning electron microscope (SEM) at a low vacuum (20 kV) and the surface and cross-section of the samples evaluated. The samples were immersed in liquid nitrogen for the cross-section study, fractured, and imaged within 30 minutes.

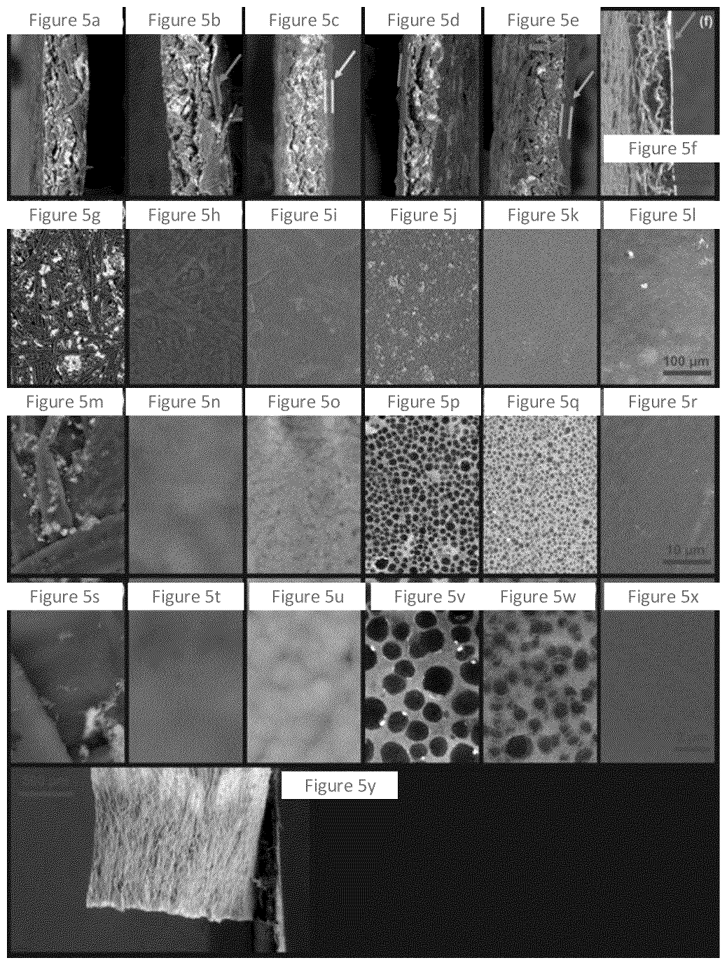

Turning to FIG. 5a to 5y, images of the different multilayer packaging materials obtained by the SEM are shown. FIGS. 5a to 5f show are SEM cross-sectional images of uncoated paper, PT, PTPBAT, PTPHBV, PTPLA, and PTPVOH, respectively using 100× magnification.

The control paper (FIG. 5a) has its familiar pattern of fibers connected with some usual cluster of mineral particles used in a papermaking process. Comparing the TPS coated paper (PT) with the control paper shows that the former has a packed structure with a layer of TPS on the right-hand side. The layer appears thin which may be due to the penetration of the TPS into the paper during the coating process.

FIGS. 5c to 5e show the cross-sections of the PTPBAT, PTPHBV, and PTPLA coated substrates, respectively. It was noted that the obtained thicknesses are close to 12 μm. However, in the case of PVOH (FIG. 5f), the thickness was about 7 μm on average indicating a degree of penetration into the paper substrate.

FIGS. 5g to 5l are surface SEM images of paper, PT, PTPBAT, PTPHBV, PTPLA, and PTPVOH, respectively at 100× magnification. A close look at FIG. 5h shows that the TPS coated paper has the usual pattern of the paper, and a thin coating of a second polymer is recognizable, which means that TPS is embedded in-between the paper with no sign of pinholes or cracks. In order to show the second layer in the cross-sectional SEM images FIG. 5b, the PT sample was immersed in liquid nitrogen and fractured and FIG. 5y shows the TPS layer on the edge, which is more than 3 mm long with no signs of cracks, pinholes, or structural damage. FIG. 5l shows a surface view of the PVOH coated sample with a recognizable paper fibers pattern.

The top view of PTPBAT (FIG. 5i) shows that the PBAT layer has covered the surface. For PTPHBV and PTPLA samples (FIGS. 5j and 5k, respectively) the second layer has a porous appearance that makes any TPS layer pattern (if any) recognizable.

FIGS. 5m to 5r are surface SEM images of paper, PT, PTPBAT, PTPHBV, PTPLA, and PTPVOH, respectively at 400× magnification and FIGS. 5s to 5x are FIGS. 5g to 5l are surface SEM images of paper, PT, PTPBAT, PTPHBV, PTPLA, and PTPVOH, respectively at 1000× magnification.

Higher magnification images of PTPBAT, PTPHBV, and PTPLA (FIGS. 5o, 5p, and 5q, respectively) show that the porous structure is not limited to PTPLA and PTPHBV. The porous structure of the PTPBAT is finer and hardly detectable at lower resolutions. The porous structure is formed when low boiling point chloroform escapes during the drying process and reported in PLA/TPS and PBAT/TPS layers. The study of the surface of the samples showed neither cracks nor pin holes.

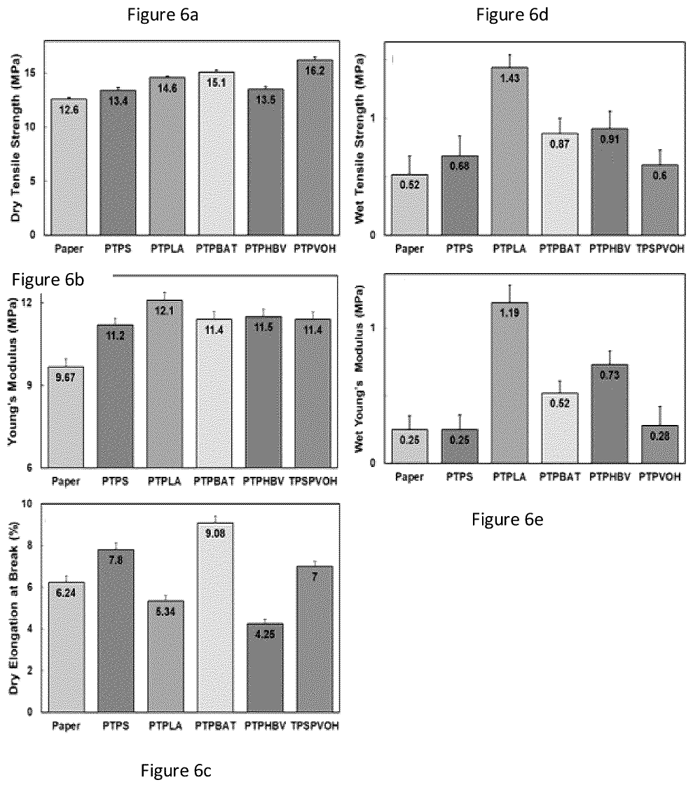

With respect to the tensile test, tensile properties of the various samples were evaluated (using dry and wet samples), and the results are shown in FIGS. 6a to 6e. In all cases, the tensile strengths and moduli (stiffness or overall material strength) of the coated samples increased compared to the paper substrate. The modulus of a material is related to the overall material strength and how a material responds to an external force. This due to the presence of the TPS layer that partly percolates into the paper to act as a binder of the paper fibers resulting in enhancement of mechanical strength and stiffness. The strength of paper is related to the fiber length, strength, and interfibrillar forces such that the TPS coating creates new bonds and interfibrillar forces, increasing in the paper's tensile strength from 12.6 (paper substrate) to 13.4 MPa in the case of PT (FIG. 6b), and modulus from 9.7 (paper substrate) to 11.2 MPa for PT (FIG. 6b). In the case of PTPHBV the tensile strength (13.5 MPa) increase was not significant compared to that of PT (13.4 MPa).

In the case of PTPLA, PTPBAT, and PTPVOH, the facing layers increased the tensile strength to 14.6, 15.1, and 16.2 MPa, respectively. With respect to the elongation at break for these polymers, the facing layer increased the modulus from 11.2 for PTPS to 12.1 for PTPLA. For PTPBAT, PTPHBV, and PTPVOH modulus, the increases were to 11.4, 11.5, and 11.4 MPa, respectively. As the modulus is measured for the strains under 0.5%, which is well below the mentioned orientation, the contribution of the facing layer in the module development may have been peripheral (FIG. 6b). In the case of PVOH, as shown in FIG. 5f, the PVOH layer thickness is less than the other samples.

The addition of TPS to the paper sheet increased its elongation at break from 6.24% to 7.8%, which could be attributed to the flexibility of the plasticized starch (TPS) compared to the paper control. However, the second layer coatings PLA, PHBV, and PVOH in the PTPLA, PTPHBV, and PTPVOH samples resulted in statistically significant elasticity variation. The decline for PTPLA (5.34%) and PTPHBV (4.25%) coated samples were associated with the stiffness and lack of flexibility of PLA and PHBV. In the case of PBAT, which has high flexibility (>800%), it also enhanced the elongation at break of the coated paper to 9.08%.

As packaging materials usually encounter humidity or moisture, there is a need to maintain their properties in such environments. Thus, to evaluate the integrity and sensitivity of the samples to moisture, the tensile test samples were completely submerged in water for 30 seconds and their tensile properties were tested and reported as wet strength.

FIG. 6d shows the tensile strengths results of the wet samples. After water immersion, the tensile strength of the paper substrate decreased from 12.6 MPa (for dry paper sample in FIG. 6a) to 0.52 MPa (for the wet paper sample in FIG. 6d). Considering the short duration of water contact (30 s), it is reasonable to assume that water molecules did not have enough time to completely penetrate the polymer binder domains in the paper sheet and swell them. Compared to the baseline paper substrate, all coated samples displayed high moisture sensitivity, and wet strength improvements. The PT and PTPVOH samples with starch and PVOH facing layer showed high moisture sensitivity and statistically significant (p<0.05) improvement.

The Young's moduli for paper, and water soluble PVOH and TPS (PTPS, and PTPVOH respectively) were 0.25, 0.25, and 0.28 MPa, respectively. For the hydrophobic polymer-coated samples, namely PTPLA, PTPBAT, and PTPHBV, the moduli were 1.19, 0.52, and 0.73 MPa, respectively, showing a 208 to 476% increase (FIG. 6e). In real-life applications, if the moisture exposure is facing PLA, PBAT, or PHBV coated paper, it is likely that the integrity of the multilayer packaging material will be maintained.

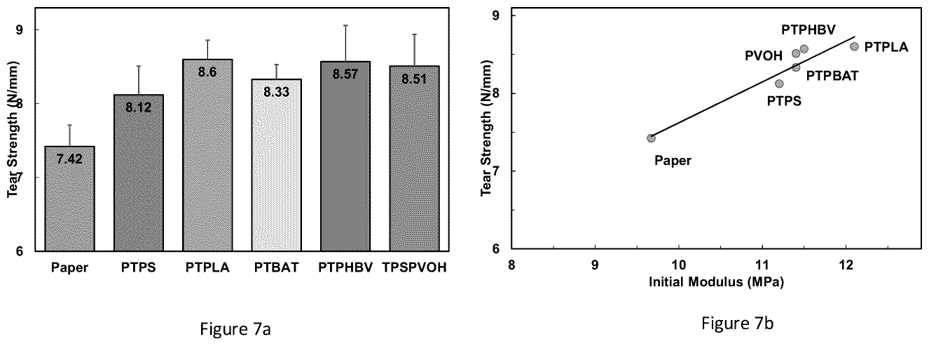

With respect to tear resistance, tear resistance is among the critical characteristics of flexible packaging, as it defines its application and affects the way the end-user can rip off the package to release the content or contents such as the product. It is also a function of the resistance of the packaging to crack propagation. For paper-based products, it usually depends on the characteristics of fibers like fiber strength, and length, and its interfibrillar bonding, which is usually determined during the papermaking process by choosing the right binder and process. The paper substrate and TPS-coated paper showed tear strength values of 7.42 and 8.12 N/m (FIG. 7a). After adding the next polymer layer (PLA, PHBV, PBAT, or PVOH), the corresponding strength values were 8.6, 8.33, 8.57, and 8.51 N/mm, respectively. Based on the SEM images for PVOH samples (FIG. 5f), a partial penetration of polymer into the paper substrate might have given some extra strength to paper fibers and changed the structure of interfibrillar forces and adhesion. However, by comparing the data with those of Young's moduli (FIG. 6b) for dry samples, it seems that there is a linear relationship between the tear strength of the samples and their moduli.

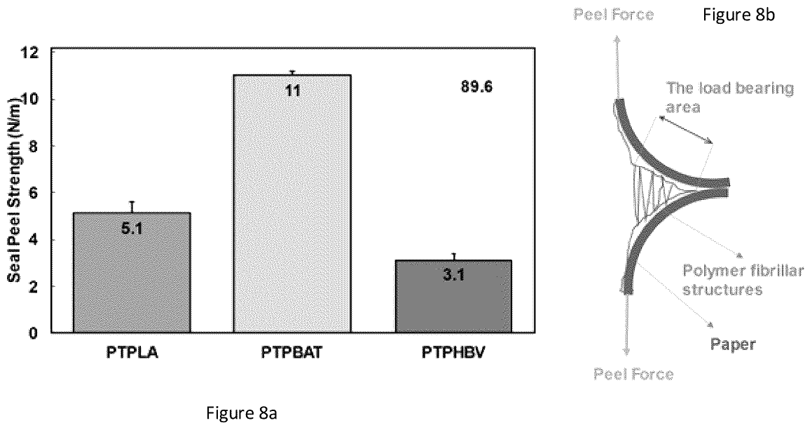

With respect to the seal peel test, the seal peel test evaluates the performance of the facing layers as a self-sufficient adhesive/hot melt to seal a package. The sealing was conducted using a common commercial heat sealer by exposing the multilayer packaging material samples to the melting temperature of the respective topcoat polymer coating for two seconds. The lap shear seal strengths of PTPLA, PTPBAT, and PTPHBV displayed were 5.1, 11, and 3.1 N/m (FIG. 8a), respectively. The higher result for PTPBAT can be attributed to a high elongation at break of PBAT, which is a common phenomenon for soft polymers used as pressure-sensitive adhesives. FIG. 8b shows the load-bearing mechanism for the seal during the test. As the gap between the sealed paper sheets widens, the sealing polymer connecting them is pulled and forms some fibrillar structures. The fibrillar structures elongate and bear load as a result. The increased opposing force will result in an elevated strength reading from the instrument. When the polymer has a longer elongation at break, they do not break early, more fibrillar structures bear the load at any given time (FIG. 8b), and the measured peeling force during the test increases, which is the case for PBAT that has the highest elongation at break (470%).

With respect to water and oxygen barrier properties, with many packaging applications, the permeation of the packaging film for a specific material needs to be in a particular range. For example, foods like pizza or fries are usually delivered in non-coated paper packages because the higher water vapor transmission rate will prevent or reduce the likelihood of them staling while hot. Still, the same packaging for salad will make them dry and change their organoleptic properties. The same is true in the case of oxygen barrier properties that can affect microbial activity (aerobic or anaerobic) and oxidation behavior (e.g., coffee and tea packaging).

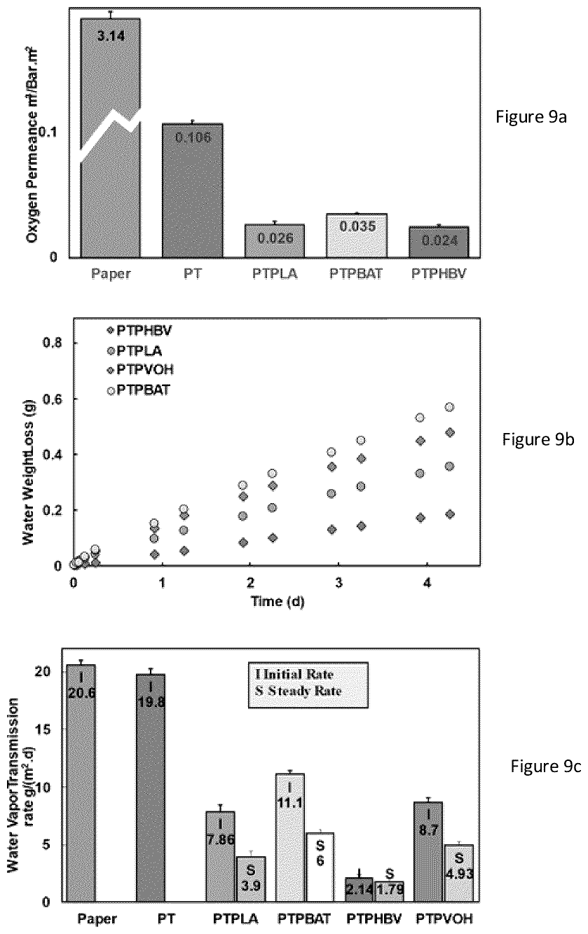

FIG. 9a shows the results for oxygen permeance. In all cases, the specimens' coated sides were facing oxygen. The addition of the TPS layer (or intermediate) reduced the permeance from 3.14 m³/Bar·m² for the base paper to 0.108 m³/Bar·m². The addition of facing second layer of PBAT, PLA, and PH BV reduced the permeance further to 0.035, 0.026, and 0.024 m³/Bar·m², respectively. The same experiment was also performed on the paper coated with PVOH, considering its widespread use to enhance oxygen barrier properties in the packaging industry. In these samples, no bubbles were observed using the experimental setup, which shows that the permeance was less than the detection limit of the test setup.

Water vapor transmission rate (WVTR) was also measured, and the weight change-time relationship is shown in FIG. 9b. The rate of weight loss is high at first and reaches a steady value after some time. FIG. 9c shows the calculated WVTR results for these samples. For PT and paper, the tests were performed for 24 h, and their initial WVTR values were 20.6 and 19.8 g/m²·d, respectively, which were not significantly different. However, the facing layer of PBAT, PHBV, PLA, and PVOH resulted in an initial WVTR of 11.05, 2.14, 7.86, and 8.7 g/m²·d, respectively, which were far less than PT (19.8 g/m²·d). The steady WVTRs of PTPBAT, PTPHBV, PTPLA, and PVOH were 6, 1.79, 3.9, and 4.93 g/m²·d, respectively. This indicated that PTPVHB is an appealing coating for packaging of moisture-sensitive food products, like potato chips. The lower permeance is mainly attributed to the high crystallinity of PHBV.

With respect to the Cobb test, the short-term resistance of packaging materials to water and oil contact is important in many practical applications. The Cobb test provides more insight with respect to the extent of water or oil absorption of the samples. In this work, water absorption tests after 60 and 180 seconds were performed and designated WCobb60 and WCobb180, respectively. The same test was performed using corn oil, at 60 and 180 seconds and the values reported as OCobb60 and OCobb180, respectively.

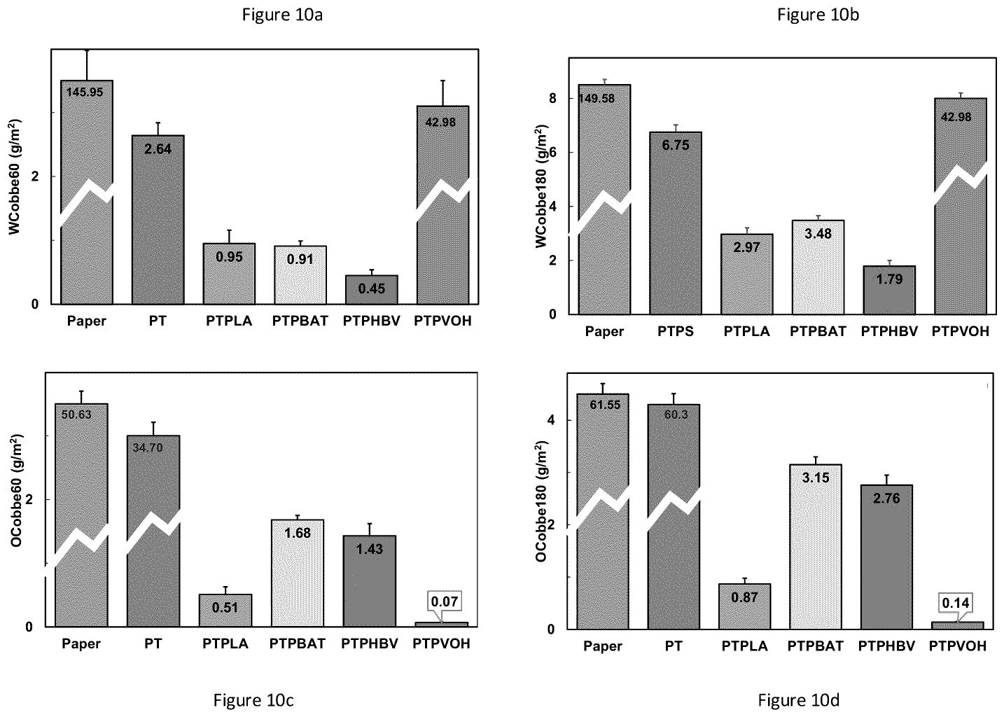

FIGS. 10a and 10b show Cobb test results with water after 60 (WCobb60) and 180 seconds (WCobb180). The first layer (TPS) application decreased the value of WCobb60 from 145.95 (for the base paper) to 2.64 g/m². As will be discussed later, the values of OCobb60 and OCobb180 for PT were 34.70, and 60.3 g/m², respectively, which are high, indicating the presence of some interfibrillar pores in the TPS-coated sample. The hydrophilic TPS-coating provided such a strong water resistance after contact with water as the TPS likely filled a substantial portion of the inter-fibrillar pores in the paper substrate. Upon contact with water, the TPS can also swell to fill micropores until the water eventually diffuses through the TPS to penetrate the paper substrate. The reason for the slowdown in the flow can be expressed using the Stokes-Einstein equation (4):

$$\\ D = \frac{kT}{6 η R}$$

where k, T, and R are Boltzmann constant, temperature, and the solute radius respectively, and D (the diffusion coefficient) is inversely proportional to r (viscosity of the medium). For a medium like the highly viscose water-swollen TPS, the amplified value of η causes a small water diffusion constant (D). Hence, the paper cannot absorb a lot of water during the brief exposure as it did in the case of the plain paper. By adding the facing layer, the diffusion is hindered further. It has been previously reported that the WCobb30 (Cobb value for 30 seconds in water) for PLA-coated Kraft paper to be approximately 7 g/m², which in this study (with a doubled head pressure and doubled time compared to theirs) has reduced to 0.95 g/m². This shows that a TPS intermediate layer under a PLA facing layer has a strong positive effect on the result.

Improved results were observed for PTPHBV and PTPBAT with 0.45 and 0.91 g/m² values for WCobb60. A high value (34.7 g/m²) for PTPVOH was observed, which could be associated with the polarity and hydrophilicity of PVOH. On the contrary, low oil absorption (OCobb60 and OCobb180) was recorded for PTPVOH sample (0.07 and 0.14 g/m², respectively), indicating a pore-free barrier film formation against oil.

The results for WCobb180 (Cobb test with water for 180 seconds) showed the same trend as WCobb60. The bare paper sample showed a WCobb180 value of 149.58 g/m², which was not significantly different from WCobb60 value (145.95 g/m²), indicating that even after 60 s, the base paper had been almost saturated with water, and further exposure did not change the weight appreciably. Interestingly, PT showed only 6.75 g/m² water absorption, which was still far from the plain paper. This indicated that the higher viscosity mentioned before could still prolong the diffusion of water molecules into the paper substrate. For PVOH coated sample, the result was 42.98 g/m², which was not too far from the WCobb60 value (34.7 g/m²). After the 60 s exposure, it is probable that starch and PVOH molecules underwent relaxation and showed some swelling and filled the pinholes, and hindered further fast diffusion of water molecules into the paper substrate. For PTPLA, PTPBAT, and PTPHBV, the WCobb180 values increased by 3.04, 3.82, and 3.98 times compared to their WCobb60 values, respectively, which are close to the three-fold increase of the test duration time from 60 to 180 seconds. For samples that showed more than a threefold increase, it can be assumed that either more pores were created or the original pores became larger in diameter during the exposure.

A Cobb test with oil is important for applications where the packaging product or the multilayer packaging material of the disclosure comes in contact with oil. For example, fried products, burgers, and/or coffee, and wraps and packaging materials require oil barrier properties to handle these products. Hence, the Cobb test values for oil after 60 seconds (OCobb60) and 180 seconds (OCobb180) that measure the weight of oil absorbed by the coated paper are tests to evaluate the oil resistance of such materials.

There are numerous types of cooking oil on the market, and the majority of them have similar structures. Corn oil was selected as a testing agent because it is one of the most frequently used oil types for the frying of french fries and the preparation of a range of other food products. A direct comparison of OCobb and WCobb test values is not possible because in general: a) the densities of oil and water are different that creates different head pressures for flow into the paper sheet, b) the viscosities are different, c) the paper binders might be more prone to property loss up on contact with either water or oil. In this study, TPS and PVOH moieties in the system change the hydrodynamic size of the coated films in water and create aggregates that can change the neighboring pore sizes, and thus the water absorption by paper fibrils that can affect the total volume and mass of the swollen system.

The OCobb60 values for the base paper and PT were 50.63 and 34.70 g/m², respectively, which showed that a significant reduction in the oil absorption could be achieved by adding the polar TPS layer to the paper (FIG. 10c). A comparison between the high OCobb60 value (34.70 g/m²) and the low WCobb60 value (2.84 g/m² FIG. 10a) for the PT sample indicated that the oil could penetrate the starch coating surface. The ability of starch to absorb oil, in combination with the small TPS layer thickness (12 μm), could have contributed to the penetration by the oil, which in the case of water were quickly filled up with water-swollen TPS. The plasticization of TPS starch with corn oil triglycerides could also change starch's morphology, resulting in the observed increase in the oil absorption.

As expected, the oil absorption after 180 seconds increased further to 61.66 and 60.3 g/m² for the base paper and PT, respectively (FIG. 7d). In the case of PTPVOH the values for OCobb60, and OCobb180 were 0.07, and 0.14 g/m², which were the least values in both tests among the samples (FIGS. 10c and 10d). The highly polar structure and crystallinity of PVOH could form a robust barrier against oil that is responsible for the observed result.

Applying the facing layer coating reduced the oil penetration substantially, irrespective of the polymer type. The OCobb60 of PTPLA, PTPBAT, and PTPHBV were 0.51, 1.68, and 1.43 g/m², respectively, which were far less than 34.7 g/m² for PT (FIG. 10c). The best result among the three was for PTPLA for which PLA has a somewhat polar nature and a Hildebrand solubility parameter (δₜ) of 21.9 MPa^{1/2}. For corn oil with typical constituents of linoleic acid (52 w %), oleic acid (31 w %), palmitic acid (13 w %), stearic acid (3 w %), and linolenic acid (1 w %) and Hildebrand solubility parameters of 18.2, 17.7, 17.7, 17.5, and 18.5 MPa^{1/2}, respectively the solubility parameter can be calculated using the following equation:

δₜ=φ₁δₜ₁+Φ₂δₜ₂+ . . . +φₙδₜₙ

where δₜ is the Hildebrand solubility of the mixture and φᵢ and δₜᵢ are the volume fraction and the solubility parameter of the ith component. For corn oil the solubility parameter is calculated to be 17.96 MPa^{1/2}, which is 3.94 MPa^{1/2} less than that of PLA. However, the difference does not suggest considerable mutual compatibility, because as a rule of thumb, polymer/solvent systems with similar polar and hydrogen bonding parameters with a Hildebrand constant difference of less than 3.6 are considered compatible.

It is worth mentioning that the corn oil ingredients with the highest solubility parameters like linolenic acid (δₜ=18.5 MPa^{1/2}) might have a little higher compatibility with PLA and hence absorption into the PLA layer. The slightly higher oil absorption of PTPHBV might be because the Hansen solubility parameter of PHBC (20.6 MPa^{1/2}) is closer to corn oil (5, =17.96) than PLA's parameter.

In the case of PBAT, the Hansen solubility parameter (19.83 MPa^{1/2}) was closer to that of corn oil compared to PLA and PHBV due to the presence of less polar hydrocarbon benzene rings in the structure. This results in more compatibility with corn oil and hence more oil absorption, which was noted in the results. Thus, if low oil absorption is important for the application under consideration, PTPBAT seems to be the best option.

In the case of PTPVOH, with a solubility parameter of 26.3 MPa^{1/2}, which results from the presence of numerous hydroxyl groups in its structure, a minute oil absorption (0.07 g/m²) was observed. The oil absorption characteristics of PVOH and its correlation with the structure and morphology of the polymer domains have been reported. The oil absorption of PTPBAT, PTPLA, and PTPHBV coated papers has increased to 3.15, 0.87, and 2.76 g/m², respectively, after 180 seconds (OCobb180).

With respect to the kit test, the kit test was used to determine the resistance of the applied polymer coatings to a range of solvents with various polarities. Unlike the Cobb test, it does not use any head pressure to evaluate the fluid penetration through the physical pores on the specimen surface, if any. In addition, the duration of the test is 15 seconds that will not allow any considerable dissolution to happen. The most polar solvent (reagent No. 1) was castor oil, which was diluted gradually to make the other testing reagents by adding heptane and toluene. A droplet of the reagents was released at a height close to the surface (13 mm) to avoid exerting extra pressure on the surface.

After testing the samples with the reagents, no signs of change in the surface structure of the coated material were observed for the applied solvents. Thus, as their test results were greater than eight as per the standard, all the studied samples can be considered “grease resistant.”

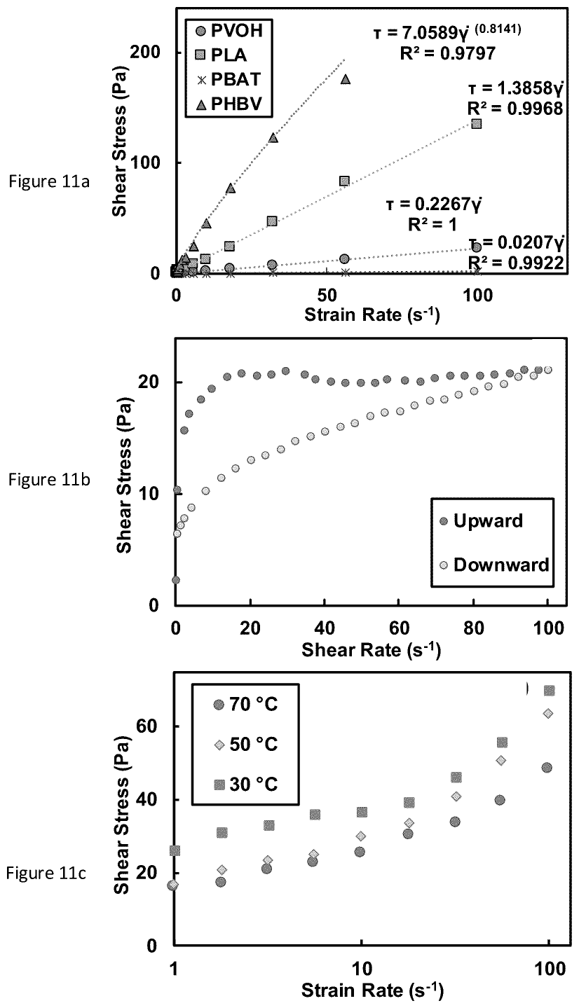

With respect to the rheology study, the application of the polymer solution on the paper is the most crucial step in fabricating the multilayer assemblies because the film quality depends on the flow properties of the solutions. FIG. 11a shows the rheology test results for the solutions with a concentration of 6 v %. The shear stress-shear rate graphs for PBAT, PVOH, and PLA solutions (FIG. 11a) were linear with Newtonian viscosities of 20.7, 22.7, and 1385.8 mPa·s, respectively. The lower viscosities of PVOH and PLA showed that the solutions could be made more concentrated in industrial production. On the other hand, PHBV's solution viscosity decreased at higher shear rates (γ) and showed pseudoplasticity. The power-law model was fitted to the data with a flow consistency index (K) of 7.0589 s^{0.8141}, and power law flow index (n) of 0.8141.

At 30 and 50° C., the TPS solutions behaved like thick honey, and the curves showed small fluctuations (FIG. 11c). The curve was smoother at 70° C. and the solution showed more fluidity, which is why the solution was heated before application. TPS solution was thixotropic (Ma et al., 2018) at 70° C. (FIG. 11b), and the values for the area under the upward (Aᵤₚ) and downward (A_{down}) curves were found to be 2009 Pa/s, and 1581 Pa/s, respectively, which resulted in a hysteresis area (ΔA_{Th}) of 428.6 Pa/s. As the typical duration of the application process is short and in the range of seconds, the thixotropic effect is negligible. For short application times, the power-law model explains the behavior, and K and n were found to be 3100 s^{0.2214} and 0.2214, respectively.

As determined by the experiments, the intermediate and facing layers substantially improved the water and oil resistance compared to the bare paper substrate, which is necessary for the packaging material of the disclosure to be used in wrapping (e.g., burgers, fried products, fresh meat, etc.). Moreover, the kit test results confirmed that the multilayer paper coating films had outstanding grease resistance. The TPS instilled excellent oxygen barrier properties to the multilayer packaging materials and the addition of the facing layer, such as PHBV further improved oxygen permeance and water vapor transmission rate by 440 and 390% respectively compared to that of only the intermediate and substrate layer combination. This result indicates that the packaging material of the disclosure can be shaped into a pouch and paper-bags to handle oxidation susceptible products, such as, but not limited to, coffee, potato chips, spices, dehydrated eggs, cheese, fried products, etc. Tensile tests showed considerable improvements in the wet tensile strengths (48-257%) and moduli (208-476%) compared to the a paper substrate layer, which is beneficial for applications where wet strength is critical. While most industrial coating processes for multilayer packaging materials utilize melt-processing technologies like coextrusion, the wet-process of the current disclosure can be expanded to melt-processing, as the selected polymers are all melt processible. Based on the test results observed in this study, PTPLA, PTPBAT, or PTPHBV are excellent compostable thermoplastics for barrier paper coating development that can be used in food or biomedical industries.

Although the current disclosure is more directed at using the novel packaging material for the transport of food items, the packaging material may also be beneficial in the fabrication of transportation packages for other products where oxygen or water has detrimental effects on the final properties or intended applications such as, but not limited to batteries, printed electronics and super capacitors, biomedical wraps, pharmaceutical products sensitive textiles, baby products and/or construction products.

Although embodiments have been described above and are shown in the accompanying drawings, it will be appreciated by those skilled in the art that variations and modifications may be made without departing from the scope as defined by the appended claims, and the scope of the claims should be given the broadest interpretation consistent with the specification as a whole.

What is claimed is:

1. A multilayer packaging material comprising:
a substrate layer;
a polar layer positioned on one side of the substrate layer; and
a non-polar layer positioned on the polar layer, opposite the substrate layer.

2. The multilayer packaging material of claim 1, wherein the polar layer is a polar starch layer.

3. The multilayer packaging material of claim 1, wherein the polar layer comprises at least one of a starch, thermoplastic starch (TPS), cellulose acetate, cellophane, or polyvinyl alcohol.

4. The multilayer packaging material of claim 1, wherein the substrate layer comprises at least one of paper, cellulose acetate, cellophane, polyvinyl alcohol.

5. The multilayer packaging material of claim 1, wherein the substrate layer comprises paper and the intermediate layer comprises thermoplastic starch (TPS).

6. The multilayer packaging material of claim 1, wherein the non-polar layer comprises at least one of polylactic acid (PLA), poly(butylene adipate-co-terephthalate) (PBAT), poly(3-hydroxybutyrate-co-3-hydroxyvalerate) (PHBV), or polyvinyl alcohol (PVOH).

7. The multilayer packaging material of claim 1, wherein a thickness of the polar layer is in the range of 0.1 μm to 1 mm.

8. The multilayer packaging material of claim 1, wherein a thickness of the non-polar layer is in the range of 0.1 μm to 1 mm.

9. The multilayer packaging material of claim 1, wherein the polar layer and the non-polar layer have different polarities.

10. A packaged product comprising:
a product for a consumer; and
a packaging surrounding the product, the packaging comprising the multilayer packaging material as defined in claim 1.

11. The packaged product of claim 10, wherein the product is a single use beverage pod.

12. The packaged product of claim 10 wherein the packaging comprises multiple pieces of the multilayer packaging material.

13. The packaged product of claim 12 wherein the multiple pieces of the multilayer packaging material are connected to each other via their non-polar layers.

14. The packaged product of claim 13 wherein the multiple pieces of multilayer packaging material are heated to bond a portion of their non-polar layers together.

15. A method of manufacturing a multilayer packaging material, the method comprising:
providing a substrate layer;
positioning a polar layer atop the substrate layer; and
positioning a non-polar layer atop the polar layer, opposite the substrate layer.

16. The method of claim 15, wherein positioning the polar layer atop the substrate layer comprises:
applying a polar layer solution to the substrate layer.

17. The method of claim 16, wherein positioning the polar layer atop the substrate layer further comprises:
drying the polar layer solution.

18. The method of claim 15, wherein positioning the polar layer atop the substrate layer comprises:
adhering a prefabricated polar layer to the substrate layer.

19. The method of claim 15, wherein positioning the non-polar layer atop the polar layer comprises:
applying a non-polar layer solution to the polar layer; and
drying the non-polar layer solution.

20. The method of claim 15, wherein positioning the non-polar layer atop the polar layer comprises:
adhering a pre-fabricated non-polar layer to the polar layer.
